(19) United States
(12) Patent Application Publication
(10) Pub. No.: US 2014/0259486 A1
(43) Pub. Date: Sep. 18, 2014

(54) PLASTIC BRISTLES INFUSED WITH CARBONATE

(71) Applicant: CHURCH & DWIGHT CO., INC., Princeton, NJ (US)

(72) Inventors: Elena Petrovicova, Princeton, NJ (US); Steven Bolkan, Hopewell, NJ (US); Laura Brandt, Lawrenceville, NJ (US); Gerhart P. Huy, Hamilton Square, NJ (US); Stephen Thong, East Grand Rapids, MI (US); Steven T. Adamy, Lawrenceville, NJ (US)

(73) Assignee: CHURCH & DWIGHT CO., INC., Princeton, NJ (US)

(21) Appl. No.: 13/828,853

(22) Filed: Mar. 14, 2013

(51) Int. Cl. A46B 9/04; C08K 3/26

(52) U.S. Cl. CPC A46B 9/04; C08K 3/26
USPC 15/167.1; 264/239; 524/424; 524/47; 524/55; 524/27; 524/377; 524/43

(57) ABSTRACT

Polymers are infused with carbonates, such as alkali metal or alkaline earth metal salts of carbonate, bicarbonate and sesquicarbonate, alone or in combination. The carbonates are soluble, soft, and have been infused within the polymeric material in a sufficient amount to provide an alkaline aqueous environment to inhibit microbes when the polymeric material is contacted with water.

### FIELD OF THE INVENTION

This invention relates to polymeric articles that comprise one or more polymers that are infused with carbonates, such as alkali or alkaline earth salts of carbonate, bicarbonate and sesquicarbonate, alone or in combination.

### BACKGROUND OF THE INVENTION

Polymeric materials such as polyurethane, HDPE and nylon (polyamide) filaments are popular in the production of consumer products. In particular, nylon filaments are frequently used to produce toothbrush bristles. This is mainly due to their good flexibility and durability during repeated soakings and washings with oral care chemicals. Toothbrush bristles are often comprised of filaments that have a smooth, cylindrical circumferential surface and may define a variety of cross-section shapes.

The surfaces of such bristles often harbor unwanted bacteria that can have a deleterious impact on healthy teeth. Also, plastics used in the manufacture of bristles can define surfaces that have undesirably low pH and conductivity properties, which can further deleteriously impact on otherwise healthy teeth.

It is well known that various additives can be incorporated during the manufacturing process of bristles. For example, U.S. Pat. No. 6,327,736 to Schaefer et al. describes additives such as calcium carbonate for use as fillers and/or nucleating agents to be incorporated into a toothbrush.

U.S. Pat. No. 5,605,756 to Sanduja, et al. discloses a process for incorporating a flavored toothpaste composition that contains a sodium hydrogen carbonate filler bonded to the bristles of a disposable toothbrush.

PCT patent publication Number WO9727029 to Ohtsubo describes a process for manufacture of an abrasive brush and cites the use of sodium carbonate as abrasive particles that can be coated onto the surface of fibers to produce an abrasive brush.

U.S. Pat. No. 2,216,333 to White et al. discloses the use of sulfur as a bactericide within an antisepticised brush, and addition of sodium carbonate to solubilize the sulfur bactericide.

U.S. Pat. No. 6,946,196 to Foss describes anti-microbial and/or anti-fungal footwear components that are formed from anti-microbial synthetic fibers, which include inorganic anti-microbial additives. The fibers can be further blended with non-anti-microbial fibers such as cotton, wool, polyester, acrylic, nylon etc. to provide anti-microbial finished fabrics. A range of fillers such as clay, calcium carbonate, and the like are used to reduce the cost of manufacture.

Japanese Patent Application JP07381415 to Yokohama et al. teaches a composite powder that contains a base powder and an alkali metal salt.

The above-cited references teach the incorporation of carbonates into various polymeric articles. However, it is well known that carbonates, such as calcium carbonate, are insoluble and are hard materials that cause undue wear on molded components. Furthermore, the use of calcium carbonate can compromise fiber tensile strength. It must also be noted that there is an advantage in personal care products such as toothbrush heads to form an alkaline aqueous environment to inhibit microbes. The use of insoluble carbonates, such as calcium carbonate, that are embedded within a molded plastic would not result in diffusion from the molded plastics to create an alkaline aqueous environment.

There remains a demand for a soft and anti-microbial agent that can be infused in a sufficient amount into polymeric articles, such as toothbrush filaments, in order to provide effective microbial inhibition.

### SUMMARY OF THE INVENTION

This invention relates to polymeric articles that comprise one or more polymers that are infused with carbonates, such as alkali metal or alkaline earth metal salts of carbonates, bicarbonates and sesquicarbonates, alone or in combination. The carbonates for use in this invention are relatively water soluble, soft, and are infused within the polymeric articles in a sufficient amount to provide an alkaline aqueous environment to inhibit microbes upon use.

### BRIEF DESCRIPTION OF THE DRAWINGS

FIG. 1 shows the pH of solutions that contained treated and untreated polyurethane coupons.

FIG. 2 shows the pH of solutions that contained treated and untreated nylon bristles.

FIG. 3 shows the pH of solutions that contained treated and untreated thermo-formed HDPE coupons.

FIGS. 4A and 4B show the pH of solutions that contained treated and untreated injection molded HDPE coupons.

FIG. 5 shows the electric conductivity of solutions that contained treated and untreated injection molded HDPE coupons.

FIG. 6 shows the electric conductivity of solutions that contained treated and untreated thermo-formed HDPE coupons.

FIG. 7 shows the settling times of sodium bicarbonate admixed with different concentrations of hydroxypropyl cellulose.

### DETAILED DESCRIPTION OF THE INVENTION

This invention relates to polymeric articles that comprise one or more polymers that are infused with carbonates, such as alkali metal or alkaline earth metal salts of carbonates, bicarbonates and sesquicarbonates, alone or in combination. The carbonates are relatively water soluble, soft, and have been infused within the polymeric articles in a sufficient amount to provide an alkaline aqueous environment to inhibit microbes upon their diffusion from the polymer.

It should be understood that one or more carbonates or bicarbonates are infused into a polymeric material to provide articles according to the invention. Furthermore, “infusion” has the meaning of entrapment of particles within substrates (i.e. polymeric materials), such that the particles may be dislodged or diffused from the substrates. It should be understood that “impregnation” is an equivalent of “infusion” in the present invention.

In more detail, the invention relates to the infusion of carbonates, such as alkali metal or alkaline earth metal salts of carbonates, bicarbonates, and/or sesquicarbonates into polymeric materials such as nylon (polyamide), nylon blends, HDPE (high-density polyethylene), polyester PBT (polybutylene terephthalate), PTT (poly(Trimethylene Terephthalate)), and TPE (thermoplastic elastomers); PET (polyethylene terephthalate), and polyurethane to provide personal care articles such as for teeth, hair and other brushing applications, tufts, dental floss and other plaque removing devices. The terms “polymeric materials” and “plastics” are regarded herein as equivalent terms. Useful carbonates are particularly selected from bicarbonates of sodium, potassium, calcium and ammonium. Preferably, the useful bicarbonate is sodium bicarbonate. Especially useful polymeric materials for the present invention are nylon and polyurethane.

### Infusion Carbonates

The infusion of carbonates into polymeric materials can be accomplished by mixing at least one carbonate as described above with molten polymeric materials, prior to extrusion or shaping of the polymeric material.

A preferred embodiment is the infusion of sodium bicarbonate into a polymeric material to provide enhanced anti-microbial properties such as an alkaline aqueous environment when the infused polymeric material is in contact with water. However, the infusion process can be difficult to accomplish because sodium bicarbonate and other carbonates of use in this invention are known to be unstable at high temperatures, including the melting temperature of most plastics. Specifically, sodium bicarbonate starts to break down to sodium carbonate at about 270° C. according to the following equation:

2NaHCO₃⇄NaCO₃+H₂O+CO₂

This conversion of sodium bicarbonate (“SBC”) to sodium carbonate is complete at approximately 400° C. within 2-3 minutes.

Another issue with regard to the infusion of carbonate into plastic materials is that the carbonate often settles quickly within the molten plastic/solvent mixture, such that only up to 1 wt. % of the carbonate is successfully infused into the plastic. The present invention has solved these problems by: optionally mixing the carbonates with at least one thickener to homogenously distribute the carbonates throughout the mixture, and thus, slow down the carbonate settling time; and/or rapidly cooling the carbonate/plastic combination; and/or adding sufficient carbonate to take into account adverse conversions of certain carbonates such as sodium bicarbonate into sodium carbonate.

At least one of the above improvements with regard to infusion of carbonates into plastics or combinations thereof is applied according to the type of polymeric material that is used. For example, for plastic materials that require a high melting temperature that is the same as or surpasses the reactive temperature of carbonates, at least one thickener is mixed with the carbonate to slow down the settling time of the carbonate within the molten polymeric mixture, which can then be rapidly cooled. For polyurethane, the carbonate can be simply added into a mixture of two monomers, which react to form the polyurethane. The carbonate is infused into the plastic as the monomers react and are polymerized. Preferred plastics such as nylon and polyurethane have a melt flow index or MFI (determined according to ISO 1133) that is high enough to form useful bristles, such as for toothbrushes, and low enough to prevent significant conversion of, for example, sodium bicarbonate (SBC) to sodium carbonate during the melting process.

Thickeners or thickening agents, which can be used to aid in the infusion of the carbonate into the plastic, are selected from polysaccharides such as starches, vegetable gums, and pectin; precipitated silica, fine talc, or chalk; polyethylene glycol, synthetic polymers such as carbomer (i.e. polyacrylic acid); polyvinyl co-polymer, homopolymer, acrylic polymer, hydroxymethyl cellulose, hydroxypropyl cellulose and mixtures thereof. The preferred thickener is hydroxypropyl cellulose. The thickener is typically mixed in a polar solvent that is selected from water, ethanol, methanol, propanol, butanol and mixtures thereof. The solvent is preferably ethanol. The thickener is used in the amount of 0.05% to 10.00%, preferably 0.2% to 5.0%, and, more preferably, 0.5% to 2.0% by weight of the total solvent. The amount of solvent used relative to the amount of polymeric material of the present invention will range from a weight ratio of 1:3 to 4:1, preferably 1:2 to 2:1. In some cases, effective infusion can be accomplished if the carbonate is mixed with the solvent without the thickener.

The amount of carbonate that is mixed with the solvent (with or without thickeners) can be from 1% to 30% of the total solvent mixture. A higher amount is possible as long as the amount of carbonate does not compromise the integrity of the solvent mixture as it is being incorporated into the polymeric materials. The integrity of the solvent mixture means that the carbonate particles do not aggregate or settle from the solvent, but remain partially saturated or in a uniform slurry. The amount of carbonate that is to be incorporated within the ready-made polymeric article is about 0.5 to 20 wt. % relative to the weight of the polymeric article. Higher infused amounts are possible depending on the initial amount of carbonate added to the solvent thickness/mixture. It is to be understood that the thickeners, if used, may remain within the plastic after the production process.

Once mixed with the molten plastics, the infusion of carbonates such as sodium bicarbonate can be achieved through traditional methods of plastic manufacture such as, and not limited to: injection molding, extrusion molding, extrusion blow molding, compression molding, thermo-form, cast and blown film manufacturing or extrusion spinning.

The plastic articles infused with carbonates induce an alkaline aqueous environment upon contact with water. Typically, it has been found that an alkalinity of at least a pH of 8 in water is reached within 15 minutes of contact of the infused plastic article with an aqueous environment. The pH declines gradually to about 7.5 after 60 minutes. For sodium bicarbonate infused nylon fibers, which are known for making toothbrush bristles, the alkalinity quickly reaches above a pH of 8 in water within 2 minutes of contact and the pH value remains well above 8 after one and half hours. This is an especially desirable property because the American Dental Association® recommends the public continually brush the teeth for about two minutes to achieve an adequate oral cleaning. The induced alkalinity achievable by the carbonate-infused bristles neutralizes the acidic oral environment (known to cause cavities) in a short amount of time.

### Example 1

### Microbicity Study

Four test pieces were produced from high-density polypropylene (“HDPE”). The control test pieces were labeled as “Virgin HDPE Smooth Side” and “Virgin HDPE Rough Side” accordingly. The test pieces were made by melting HDPE at 130° C., and then pouring the molten HDPE into molds. A third test piece, “SBC surface coat,” was produced by molding HDPE as above described and then sodium bicarbonate particles were coated uniformly on the surface of the test piece. A fourth test piece, “20% SBC incorporated,” was produced by mixing sodium bicarbonate with ethanol, and the solvent mixture incorporated into the melted HDPE prior to pouring the molten HDPE into a mold. A final infusion of 20% SBC (20 wt % of test piece) was achieved. Each test piece had a dimension of 1×5×⅛ inches and weighed about 16-18 grams. Test pieces of the mentioned dimension and weight in this and other experiments are referred to herein as “coupons.”

The surface of each of the four coupons was coated with three test organisms: E. coli ATCC 8739, P. aeruginosa ATCC 9027, and S. aureus ATCC 6538. Specifically, the control coupons of HDPE comprised virgin smooth and rough sides, and the microbes were applied to the smooth and rough sides of the coupons in accordance with ISO 22196. The results are shown as cfu/coupon vs. function of time in Table 1. A significant antimicrobial effect for the bicarbonate infused coupon was achieved, while no loss in viable bacterial counts was observed With the untreated control coupons. A minor reduction in bacterial count was found with the surface coated coupon.

TABLE 1

| | t0 | Final | Log |
|---|---|---|---|
| | (cfu/coupon) | (cfu/coupon) | reduction |
| Virgin HDPE Smooth Side | 7.87E+05 | 2.01E+6 | 0 |
| Virgin HDPE Rough Side | 7.87E+05 | 7.32E+06 | −1 |
| SBC surface coat | 7.87+05 | 4.96E+04 | 1 |
| 20% SBC incorporated | 7.87E+05 | 1.02E+03 | 5 |

SBC = sodium bicarbonate;
t0 = time zero;
cfu = colony forming units

### Example 2

### Conductivity and pH Profile Studies

Plastic coupons that were infused with SBC and untreated plastic coupons that were manufactured by various molding techniques were immersed in water, and observed for pH and conductivity as a function of time. The results are presented in FIGS. 1 through 5.

A coupon from untreated polyurethane was made by mixing an alcohol and isocyanate monomers without the inclusion of SBC. The monomers were allowed to polymerize without heating. Treated polyurethane coupons were made by mixing SBC with a solvent, then adding the SBC/solvent mixture to a monomer mixture prior to polymerization. Three sets of SBC-treated polyurethane coupons were made; the first set had a final infusion of SBC in the amount of 10 wt. % per coupon, the second set had a final infusion of SBC in the amount of 2 wt. % per coupon, and the third set had a final infusion of SBC in the amount of 5 wt. % per coupon. Each coupon had a dimension of 1×5×⅛ inches and weighed about 16-18 grams as above described. All test polyurethane coupons were immersed in one liter of water, and the pH values of the water samples were measured over time.

As shown in FIG. 1, the control polyurethane coupon (no SBC) yielded a consistent pH value of about 5.25 in the span of 250 minutes. Meanwhile, the treated polyurethane coupons (infused with SBC) all yielded a pH value of at least 6 in the span of 250 minutes.

Untreated nylon bristles were made from nylon beads PA 6-12 (condensation product of 1,10-decane dicarboxylic acid and 1,6-hexamethylene diamine, also known as Vestamid D16) that were melted at 220° C. for a few seconds, subsequently cooled then extruded through a die to form filaments. The filaments were then bundled to become bristles. A first set of treated nylon bristles was formed by mixing SBC with ethanol and the SBC/ethanol mixture added to melted nylon beads PA 6-12. Bristles were formed by the same procedure as the untreated sample. This first set was labeled as “core.” A second set of treated nylon bristles was similarly produced, in which SBC was mixed in ethanol and the SBC/ethanol mixture added to melted nylon beads. Instead of extrusion through a die, a co-extrusion was performed through a mold, so that a sheath was produced along with a core. This second set was labeled as “sheath.” The core set had a final infusion of SBC in an amount of 0.3 wt. % relative to the weight of the bristles, and the sheath set had a final infusion of SBC in an amount of 1 wt. % relative to the weight of the bristles. All test bristles were immersed in one liter of water, and the pH values of the water samples were measured over time.

It can be seen from FIG. 2 that the control nylon bristles yielded a consistent acidic pH value of about 5.5 for the entire experiment (326 minutes), whereas both of the treated nylon bristles immediately yielded a pH value above 8.5 over a span of 150 minutes before the pH became steady at about 7.8. This observed property is desirable for making toothbrush bristles because, as mentioned hereinabove, an alkaline condition neutralizes the acidic oral environment.

Untreated HDPE coupons were made by melting about 16-18 grams of HDPE at 130° C. for under a minute and the melted HDPE sample was poured into a series of molds to produce a set of test coupons, each with a dimension of about 1×5×⅛ inches that weighed about 16-18 grams. Treated HDPE coupons were made by the same procedure as above, except that SBC was mixed with ethanol and the SBC/ethanol mixture was added to the melted HDPE prior to molding. A set of treated HDPE coupons with a final infusion of SBC in the amount of 10 wt. % per coupon was produced. The infused coupons were known as “thermo-formed.” Each test coupon was immersed in one liter of water, and the pH values of the water samples were measured over time.

Similar to FIG. 2, FIG. 3 also shows that the control HDPE coupons yielded a consistent acidic pH value of about 5.5 throughout the entire experiment (350 minutes), whereas the treated HDPE coupons yielded an immediate pH value above 8.0, which remained consistently over a span of about 480 minutes.

A set of untreated HDPE coupons was made from molten HDPE, which was then injected into a mold to produce a set of coupons each with a dimension of about 1×5×⅛ inches and weight of about 16-18 grams. Treated HDPE coupons were made by the same procedure above, except that SBC was mixed with ethanol and the SBC/ethanol mixture was added to the molten HDPE prior to injection into the mold. A set of treated HDPE coupons with a final infusion of SBC in the amount of 10 wt. % per coupon was produced. Each test coupon was immersed in one liter of water, and the pH values of the water samples were measured over time.

FIG. 4B shows that the control HDPE coupons yielded a consistent acidic pH value of about 5.3 for a span of 30 minutes, whereas FIG. 4A shows that the treated HDPE coupons yielded an immediate pH value about 7.0 that then climbed upward to above 8.0, and then gradually became steady at about 7.6 in the span of 350 minutes.

Water samples that contained the treated and untreated injection-molded HDPE coupons from the previous example were also measured for electric conductivity. The measure of electric conductivity is consistent with the pH value and illustrates an amount of alkali being directed into the water sample from the infused coupon. As shown in FIG. 5, the water sample that contained untreated HDPE coupons had a conductivity consistently less than 1.5 μS/cm over a span of 400 minutes, whereas the water sample that contained the treated HDPE coupons immediately had a conductivity over 2 μS/cm, and the value climbed to 16 μS/cm after about 150 minutes.

Water samples that contained the treated thermoformed HDPE coupons were also measured for electric conductivity. It can be seen in FIG. 6 that the water sample immediately had an electric conductivity of about 150 μS/cm, the value climbed to over 750 μS/cm and then became steady at just below 750 μS/cm after about 150 minutes.

### Example 3

### Dispersion Studies

A dispersion of 10% Grade 1 sodium bicarbonate was prepared in an ethanol solution having 0%, 0.05%, 0.2%, 0.5% and 1% by weight cellulosic polymer Klucel HCS (a thickener). The ethanol samples were each placed in a cuvette about 1×1×3 cm in dimension. Percent transmittance (% T) at 520 nm in the middle of the cuvette was measured with time using a Cary 300 Bio UV-Visible spectrophotometer. Plots of % T versus time for each sample are shown in FIG. 7. It can be seen from FIG. 7 that high readings close to 10² of % T at 520 nm were obtained for samples that contained 0%, 0.05% and 0.2% of thickener, which suggests that in these samples, sodium bicarbonate quickly settled. However, for the sample that contained 0.5% thickener, the measurement was close to 10¹, and for the sample that contained 1% thickener, the measurement was below 10⁰, which suggests total obscurity. It can be deduced from the results that at the 0.5% thickener concentration, the settling time slowed down by at least a hundred seconds, which is sufficient for keeping the sodium bicarbonate in suspension while the mixture is added to a melted polymeric material.

### Example 4

### Infusion of Sodium Bicarbonate into Nylon (Polyimide) Beads

Infusion with No Heat

A series of infusions were performed using nylon beads PA 6-12 (same as those in Example 2). The supplied beads had a transparent and smooth appearance. The following thickener (Klucel HCS)/ethanol solutions were prepared:

| Sample | Klucel HCS (g) | Ethanol (200 proof) (g) |
|---|---|---|
| KE-1 | 0.5 | 99.5 |
| KE-2 | 0.2 | 99.8 |

The following dispersions were made:

| | Ethanol | KE-1 | KE-2 | | |
|---|---|---|---|---|---|
| | (200 | (0.5% | (0.2% | Sodium | |
| | proof) | Klucel) | Klucel) | Bicarbonate | Nylon |
| Sample | (g) | (g) | (g) | Grade 1 (g) | beads (g) |
| A | 22.00 | | | 3.00 | 11.30 |
| B | | 22.00 | | 3.00 | 11.30 |
| C | | | 22.00 | 3.00 | 11.30 |

The dispersion samples were each placed in a closed 60 ml glass jar. The jars were shaken for about 10 seconds and the beads removed from each of the jars to allow drying. The beads were subsequently examined with optical microscopy. For sample A, it was observed that the treated beads were largely devoid of bicarbonates, except for some rough sides on the beads, where a few particles of SBC were seen. For sample B, more bicarbonate particles were seen stuck onto the beads in clusters. For sample C, numerous bicarbonate particles appeared to be stuck on the beads and the particles appeared to be more uniformly distributed than in sample B.

Infusion with Heat

Samples D, E and F were each produced according to the specifications of samples A, B and C. With the knowledge from the supplier that the beads had a softening temperature at 180° C. and the melting temperature was specified to be 215° C., the beads from all samples were heated to 210° C. for 3 minutes, and then cooled. In sample D (equivalent to A), it appeared that the bicarbonate particles largely migrated to the spaces between the beads. For Samples E and F (equivalent to B and C), the bicarbonate particles adhered to the beads well, producing numerous white patches.

The invention is not limited to providing bristles for teeth, but also for any device that requires bristles such as, but not limited to, a hairbrush and other brushing applications, tufts, dental floss and other plaque removing devices.

1. Polymeric bristles comprising at least one polymeric material infused with at least 0.3 wt. % relative to said polymeric bristles of a bicarbonate salt.

2. The bristles of claim 1, wherein polymeric material is infused with at least 0.3 to about 20 wt. % relative to said polymeric bristles of said bicarbonate salt.

3. The bristles of claim 1, wherein said polymeric material is selected from nylon, HDPE, polyester PBT, PTT, PET, and polyurethane, alone or in combination.

4. The bristles of claim 3, wherein said polymeric material is polyurethane or nylon.

5. The bristles of claim 1, wherein said bicarbonate salt is selected from bicarbonates of sodium, potassium, calcium and ammonium.

6. The bristles of claim 5, wherein said bicarbonate salt is sodium bicarbonate.

7. Polymeric bristles comprising at least one polymeric material infused with at least one bicarbonate salt and at least one thickener.

8. The bristles of claim 7, wherein said polymeric material is selected from nylon, HDPE, polyester PBT, PTT, PET, and polyurethane, alone or in combination.

9. The bristles of claim 7, wherein said polymeric material is polyurethane or nylon.

10. The bristles of claim 7, wherein said at least one thickener is selected from starches, vegetable gums, and pectin; precipitated silica, fine talc, chalk; polyethylene glycol, synthetic polymers; polyvinyl co-polymer, homopolymer, acrylic polymer or copolymer and mixtures thereof.

11. The bristles of claim 7, wherein said at least one thickener is hydroxymethyl cellulose or hydroxypropyl cellulose.

12. The bristles of claim 7, wherein said at least one bicarbonate salt is selected from bicarbonates of sodium, potassium, calcium and ammonium.

13. The bristles of claim 12, wherein said bicarbonate salt is sodium bicarbonate.

14. A method for producing polymeric bristles, comprising melting or decomposing at least one polymeric material; mixing at least one bicarbonate salt with at least one thickener; combining said mixture of bicarbonate salt and thickener with said melted or decomposed polymeric material to form a treated polymeric material; and molding or shaping said treated polymeric material to form polymeric bristles.

15. The method of claim 14, wherein said bicarbonate salt is present in amounts of at least 0.3% to about 20 wt. % of said polymeric bristles.

16. The method of claim 14, wherein said polymeric material is selected from nylon, HDPE, polyester PBT, FTT, PET, and polyurethane, alone or in combination.

17. The method of claim 16, wherein said polymeric material is polyurethane or nylon.

18. The method of claim 14, wherein at least one solvent is added to said mixture of bicarbonate salt and thickener.

19. The method of claim 18, wherein said at least one solvent is selected from water, ethanol, methanol, propanol, butanol and mixtures thereof.

20. The method of claim 19, wherein said solvent is ethanol.

21. The method of claim 18, wherein said at least one thickener is present in the amount of 0.2 to 5 wt. % relative to said solvent.

22. The method of claim 14, wherein said at least one thickener is selected from starches, vegetable gums, and pectin; precipitated silica, fine talc, or chalk; polyethylene glycol, synthetic polymers; polyvinyl co-polymer, homopolymer, acrylic polymer, hydroxymethyl cellulose, hydroxypropyl cellulose and mixtures thereof.

23. The method of claim 14, wherein said at least one bicarbonate salt is selected from bicarbonates of sodium, potassium, calcium and ammonium.

24. A toothbrush containing the polymeric bristles of claim 1.
